(19) United States
(12) Patent Application Publication
(10) Pub. No.: US 2010/0027384 A1
(43) Pub. Date: Feb. 4, 2010

(54) OPTICAL HEAD DEVICE, OPTICAL INFORMATION RECORDING/REPRODUCING DEVICE AND ERROR SIGNAL GENERATION METHOD

(76) Inventor: Ryuichi Katayama, Tokyo (JP)

Correspondence Address: Mr. Jackson Chen, 6535 N. STATE HWY 161, IRVING, TX, 75039, US

(21) Appl. No.: 12/444,202

(22) PCT Filed: Sep. 3, 2007
(86) PCT No.: PCT/JP2007/067134

§ 371 Date: Apr. 3, 2009

(30) Foreign Application Priority Data
Oct. 6, 2006 (JP) 2006-275019

(51) Int. Cl. G11B 7/00

(52) U.S. Cl. 369/44.23; 369/109.01; G9B/7

(57) ABSTRACT

A diffractive optical element generates main and two sub beams from an output light of a light source. An objective lens focuses the main and two sub beams on an optical recording medium. An optical detector receives the main and two sub beams reflected by the optical recording medium. The diffractive optical element is divided into six regions having different optical characteristics by a tangential direction division line corresponding to the tangential direction of the optical recording medium, first and second radial direction division lines corresponding to the radial direction thereof. A light in the first sub beam passing an intersection of the first radial and tangential direction division lines passes a region near the center of the objective lens. A light in the second sub beam passing an intersection of the second radial and the tangential direction division lines passes a region near the center of the objective lens.

### TECHNICAL FIELD

The present invention relates an optical head device and an optical information recording/reproducing device which carry out recording to or reproducing from an optical recording medium having grooves, and an error signal generation method thereof.

### BACKGROUND ART

In recordable or rewritable type recording medium, grooves are formed to compose a track. As a method for detecting of a track error signal in such an optical recording medium, the push-pull method is known. However, in a track error signal based on a simple push-pull method, an offset is induced when the objective lens of the optical head device is shifted to the radial direction of the optical recording medium. The existence of the offset causes operations of the track servo to be unstable, which disables the normal recording or the reproducing on the optical recording medium. As a detection method for suppressing the offset caused by such a lens shift, a differential push-pull method is known.

On the other hand, the astigmatism method is known as a detection method of a focus error signal for the optical recording medium. However, in a focus error signal based on a simple astigmatism method, a groove cross noise is induced when the light focus spot on the optical recording medium intersects the groove on the optical recording medium. The groove cross noise causes the operation of the focus servo to be unstable, which disables normal recording or reproducing of the optical recording medium. As a detection method of a focus error signal for suppressing such groove cross noise, a differential astigmatism method is known.

In recording type or the rewritable type optical recording media, there are the groove recording type and the land/groove recording type optical recording media. On the groove recording type optical medium, recording or reproducing is performed only on the groove. The DVD-R, DVD-RW, HD DVD-R and HD-DVD-RW belong to this type. On the land/groove recording type optical recording medium, recording or reproducing is performed both for the land and the groove. The DVD-RAM and HD DVD-RAM belong to this type. The land and the groove correspond to the top and bottom of the groove respectively from a viewpoint of the direction from the incident light to the optical recording medium.

The pitch of the groove on the groove recording type medium is different from that of the land/groove recording type. It is required for the optical head device and the optical information recording/reproducing device to detect the track error signal based on the differential push-pull method and the focus error signal based on the differential astigmatism method for the plural types of the optical recording media having different groove pitches to each other as mentioned above.

In the Japanese Laid-Open Patent Application JP-A-Heisei, 11-219529 (referred to as the patent document 1), an optical pickup device for detecting the focus error signal is described. This optical pickup device includes a light source, a diffraction grating, an objective lens, a hologram and a single photo detector. The light source emits an output light to the recording medium. The diffraction grating decomposes the output light emitted by the light source into a main beam and at least two sub beams. The objective lens focuses the main beam and the sub beams which are decomposed by the diffraction grating onto the recording medium independently to each other. The hologram decomposes the reflection light which is reflected by the recording medium and passed through the objective lens into a first diffraction beam and a second diffraction beam, in which their focal distances differ from each other, and diffracts to one side direction of the output light axis of the light source. The single photo detector is provided with light receiving elements which are divided into plural elements in order to receive the first diffraction beam and the second diffraction beam and detect the focus error signal on the basis of the received diffraction beams.

In the Japanese Laid-Open Patent Application JP-P2005-317106A (referred to as the patent document 2), an optical head device for obtaining a focus error signal and a track error signal is disclosed. This optical head device has a light source, an objective lens and an optical detector. The objective lens focuses the output light from the light source onto a disc type optical recording medium having a groove which forms a track. The optical detector receives a reflection light from the recording medium. The optical head device has a beam generating means for generating a main beam, a first sub beam and a second sub beam, which are focused on the optical recording medium by the objective lens. This first sub beam is composed of first and second parts in which a flat surface including the optical axis serves as the boundary thereof. The second sub beam is composed of third and fourth parts in which a flat surface including the optical axis serves as the boundary thereof. The beam generating means further has a beam generating means which is configured such that the strengths of those first to fourth parts becomes the distribution described below. The first part of the first sub beam and the fourth part of the second sub beam differ from the corresponding parts of the main beam with regard to the strength distribution which is normalized in accordance with the strength on the optical axis on the section vertical to the optical axis. Together with it, the second part of the first sub beam and the third part of the second sub beam are approximately equal to the corresponding parts of the main beam with regard to the strength distribution which is normalized in accordance with the strength on the optical axis on the section vertical to the optical axis. The optical detector individually receives: the main beam reflected by the optical recording medium; the first and second parts of the first sub beam reflected by the optical recording medium; and the third and fourth parts of the second sub beam reflected by the optical recording medium, as the reflection lights from the optical recording medium, in order to detect the focus error signal and/or the track error signal from the respective beams.

In the Japanese Laid-Open Patent Application JP-A-Heisei, 9-81942 (referred to as the patent document 3), an optical head device is described. This optical head device can detect a track error signal based on the differential push-pull method and a focus error signal based on the differential astigmatism method for plural types of optical recording media having different groove pitches to each other. In this optical head device, the output light from a semiconductor laser serving as a light source is decomposed into the three lights of: a 0th order light serving as a main beam; and ±1st diffracted lights serving as sub beams, by a diffractive optical element that will be described later. Those lights are focused on a same track of a disc serving as an optical recording medium by an objective lens. The reflection light of the main beam and the reflection lights of the sub beams, which are reflected by the disc, are received by an optical detector. The optical detector has a plurality of light receivers and based on an output from a light receiver for receiving the reflection light of the main beam, the optical head device detects a push-pull signal MPP and a focus error signal MFE, which correspond to the main beam. Also, based on an output from a light receiver for receiving the reflection lights of the sub beams, the optical head device detects a push-pull signal SPP and a focus error signal SFE, which correspond to the sub beams. The track error signal DPP based on the differential push-pull method and the focus error signal DFE based on the differential astigmatism method are given by the following equations.

DPP=MPP−K1×SPP (K1 is a constant)

DFE=MFE+K2×SFE (K2 is a constant)

FIG. 1 is a plan view of the diffractive optical element of the foregoing optical head device. The diffractive optical element 3a is divided into the two regions of regions 41a, 41b by a division line that passes through the optical axis of an incident light and corresponds to the tangential direction of the disc, and diffraction gratings are formed in the respective regions. The direction of the diffraction grating is the direction corresponding to the radial direction of the disc, and the patterns of the diffraction gratings have the shapes of straight lines arranged at a same pitch. The phase of the diffraction grating in the region 41a and the phase of the diffraction grating in the region 41b are different from each other by about 180°. Thus, the phase of the +1st diffracted light from the region 41a and the phase of the +1st diffracted light from the region 41b are different from each other by about 180°, and the phase of the −1st diffracted light from the region 41a and the phase of the −1st diffracted light from the region 41b are different from each other by about 180°. The circle indicated by a dashed line in FIG. 1 corresponds to the section of the incident light.

An optical head device in which the diffractive optical element 3a is replaced with a diffractive optical element 3b shown in FIG. 2 is also considered. FIG. 2 is a plan view of the diffractive optical element 3b. The diffractive optical element 3b is divided into the four regions 42a to 42d by a division line corresponding to the tangential direction and a division line corresponding to the radial direction of the disc which pass through the optical axis of the incident light, and the diffraction gratings are formed in the respective regions. The direction of the diffraction grating is the direction corresponding to the radius direction of the disc, and the patterns of the diffraction gratings have the shapes of the straight lines arranged at a same pitch. The phases of the diffraction gratings in the regions 42a, 42d and the phases of the diffraction gratings in the regions 42b, 42c are different from each other by about 180°. Thus, the phases of the +1st diffracted lights from the regions 42a, 42d and the phases of the +1st diffracted lights from the regions 42b, 42c are different from each other by about 180°, and the phases of the −1st diffracted lights from the regions 42a, 42d and the phases of the −1st diffracted lights from the regions 42b, 42c are different from each other by about 180°. The circle indicated by a dashed line in FIG. 2 corresponds to the section of the incident light.

FIGS. 3A to C show calculation examples of the focus error signal. In FIGS. 3A to C, calculation examples are shown in which, for the two regions divided by the straight line that passes through the center of the objective lens and is parallel to the tangential direction of the disc, the phase of the sub beam in one region and the phase of the sub beam in the other region are different from each other by about 180°.

FIG. 3A shows a calculation example of the focus error signal MFE of the main beam which is normalized by a sum signal MSUM corresponding to the main beam. FIG. 3B shows a calculation example of the focus error signal SFE of the sub beam which is normalized by a sum signal SSUM corresponding to the sub beam. FIG. 3C shows a calculation example of the focus error signal DFE of the astigmatism method which is normalized by 2×MSUM and K2=MSUM/SSUM. The horizontal axis of the graph indicates the defocus amount of the disc, and the vertical axis indicates the signal level of the focus error signal. The black dots in the graph represent the focus error signal when the light focus spot is located on the land, and the white dots represent the focus error signal when the light focus spot is located on the groove. The calculation condition is that: the wavelength of the light source is 405 nm, the numeric aperture of the objective lens is 0.65, the pitch of the groove is 0.68 μm, and the depth of the groove is 45 nm.

In the calculation examples shown in FIGS. 3A to C, when only the main beam is used to detect the focus error signal based on a simple astigmatism method, as shown in FIG. 3A, the waveform of the focus error signal on the land and the waveform of the focus error signal on the groove are different from each other, so that the groove cross noise is generated. On the contrary, when the main beam and the sub beam are used to detect the focus error signal based on the differential astigmatism method, as shown in FIG. 3C, the waveform of the focus error signal on the land and the waveform of the focus error signal on the groove are coincident with each other near the point of origin so that the drop of the groove cross noise can be expected. However, they are different from each other in the parts other than the origin, so that the groove cross noise can not be sufficiently suppressed. This is because the waveform of the focus error signal corresponding to the main beam shown in FIG. 3A and the waveform of the focus error signal corresponding to the sub beam shown in FIG. 3B are not opposite to each other on the land and on the groove in the parts except the vicinity of the origin, so that the difference between the waveforms on the land and on the groove are not sufficiently canceled by adding the waveforms.

The focus error signal in an optical head device that uses the diffractive optical element 3a becomes the signal shown in FIGS. 3A to C respectively. Thus, in an optical head device that uses the diffractive optical element 3a, the range in which the waveforms of the respective focus error signals on the land and on the groove are coincident with each other, namely, the range of the defocus amount in which the groove cross noise can be suppressed by the differential astigmatism method is narrow and the groove cross noise cannot be sufficiently suppressed.

FIG. 8 shows the optical paths of the main beams and the sub beams from a diffractive optical element to an objective lens in an optical head device that uses a diffractive optical element. Here, the diffractive optical element 3 in FIG. 8 corresponds to the diffractive optical element 3b. A main beam 16a, which transmits through the diffractive optical element 3b as the 0th order light, is sent to an objective lens 6 without being deflected. Therefore, the optical axis of the main beam 16a inputted to the objective lens 6 passes through the center of the objective lens 6. On the contrary, a sub beam 16b, which is diffracted as the +1st diffracted light by the diffractive optical element 3b, is deflected towards the upper side on the drawing at the diffractive optical element 3b and sent to the objective lens 6. Therefore, the optical axis of the sub beam 16b inputted to the objective lens 6 is deflected to the upper side on the drawing with respect to the center of the objective lens 6 without passing through the center of the objective lens 6. A sub beam 16c diffracted as a −1st diffracted light is deflected to the lower side on the drawing at the diffractive optical element 3b and sent to the objective lens 6. Therefore, the optical axis of the sub beam 16c inputted to the objective lens 6 is deflected to the lower side on the drawing with respect to the center of the objective lens 6 without passing through the center of the objective lens 6.

The positional relation of the section of the incident light inputted to the objective lens 6 and the objective lens 6 at this time is shown in FIGS. 4A to C. FIG. 4A shows the positional relation of the section of the main beam 16a and the objective lens 6. The center of a section 18a of the incident light indicated by the dashed line on the drawing and the center of the objective lens 6 are coincident with each other.

FIG. 4B shows the positional relation of the section of the sub beam 16b and the objective lens 6. The center of the section 18b of the incident light indicated by the dashed line on the drawing is dislocated to the upper side on the drawing with respect to the center of the objective lens 6. The two straight lines indicated by the dotted lines on the drawing correspond to the two division lines of the diffractive optical element 3b respectively and pass through the center of the section 18b of the incident light. Thus, the rate of the light diffracted in the regions 42a, 42b of the diffractive optical element 3b and inputted to the objective lens 6 among the sub beam 16b is lower than the rate of the light diffracted in the regions 42c, 42d of the diffractive optical element 3b and inputted to the objective lens 6 among the sub beam 16b.

FIG. 4C shows the positional relation of the section of the sub beam 16c and the objective lens 6. The center of a section 18c of the incident light indicated by the dashed line on the drawing is dislocated to the lower side on the drawing with respect to the center of the objective lens 6. The two straight lines indicated by the dotted lines on the drawing correspond to the two division lines of the diffractive optical element 3b and pass through the center of the section 18c of the incident light. Thus, the rate of the light diffracted in the regions 42a, 42b and inputted to the objective lens 6 among the sub beam 16b is higher than the rate of the light diffracted in the regions 42c, 42d of the diffractive optical element 3b and inputted to the objective lens 6 among the sub beam 16b.

The focus error signal in an optical head device that uses the diffractive optical element 3b is improved as compared with the signals shown in FIGS. 3A to C, but not sufficiently. That is, even in an optical head device that uses the diffractive optical element 3b, the range in which the waveforms of the respective focus error signals on the land and on the groove are coincident with each other, namely, the range of the defocus amount in which the groove cross noise can be suppressed by the differential astigmatism method is narrow, and the groove cross noise cannot be sufficiently suppressed.

### DISCLOSURE OF INVENTION

An object of the present invention is to provide an optical head device, an optical information recording/reproducing device and the error signal generation method which enable to obtain a favorable focus error signal in which the groove cross noise is sufficiently suppressed.

Another object of the present invention is to provide an optical head device, an optical information recording/reproducing device and an error signal generation method which enable to obtain a favorable focus error signal for plural types of optical recording media respectively having pitches different from each other.

In an aspect of a present invention, an optical head device includes: a light source, a diffractive optical element, an objective lens and an optical detector. The diffractive optical element generates at least a main beam, a first sub beam and a second sub beam from an output light outputted by the light source. The objective lens focuses the main beam, the first sub beam and the second sub beam generated by the diffractive optical element on an optical recording medium. The optical recording medium is disc type and has a groove which forms a plurality of tracks. The optical detector receives a reflection light of the main beam, a reflection light of the first sub beam and a reflection light of the second sub beam which are reflected by the optical recording medium. The diffractive optical element is divided into six regions having different optical characteristics to each other by a tangential direction division line corresponding to a tangential direction of the optical recording medium, a first radial direction division line and a second radial direction division line which correspond to a radial direction of the optical recording medium. A light in the first sub beam passing through an intersection of the first radial direction division line and the tangential direction division line passes through a region near a center of the objective lens. A light in the second sub beam passing through an intersection of the second radial direction division line and the tangential direction division line passes through a region near the center of the objective lens.

In an optical head device of a present invention, a light in the first sub beam passing through an intersection of the second radial direction division line and the tangential direction division line passes through an outside region of an aperture of the objective lens. A light in the second sub beam passing through the first radial direction division line and the tangential direction division line passes through an outside region of the aperture of the objective lens.

Further, in an optical head device of a present invention, the diffractive optical element has a diffraction grating. The diffraction grating is divided into the six regions as said above. The phase of the diffraction grating in each of the regions is different from the phase of the diffraction grating in an adjacent region of the regions by approximately 180°.

In an optical head device of a present invention, the six regions are classified into a first region group and a second region group. The first region group includes: an upper left region in a left side of the tangential direction division line and an upper side of the first radial direction division line and the second radial direction division line; a center right region in a right side of the tangential direction division line and pinched between the first radial direction division line and the second radial direction division line; and a lower left region in a left side of the tangential direction division line and a lower side of the first radial direction division line and the second radial direction division line. The second region group includes: an upper right region in a right side of the tangential direction division line and an upper side of the first radial direction division line and the second radial direction division line; a center left region in a left side of the tangential direction division line and pinched between the first radial direction division line and the second radial direction division line; and a lower right region in a right side of the tangential direction division line and a lower side of the first radial direction division line and the second radial direction division line. The phase of the diffraction grating in the first region group and the phase of the diffraction grating in the second region group are different from each other by approximately 180°.

In an optical head device of a present invention, the main beam, the first sub beam and the second sub beam are a 0th order light, a +1st light and a −1st light generated by decomposing the output light outputted by the light source, respectively. Further, the objective lens focuses the main beam, the first sub beam and the second sub beam on a same track of the plurality of tracks.

Also, an optical information recording/reproducing device of a present invention includes the above mentioned optical head device, a first circuit, a second circuit and a third circuit. The first circuit drives the light source. The second circuit detects an RF signal recorded on the optical recording medium, a focus error signal and a track error signal based on a signal outputted by the optical detector. The third circuit drives the objective lens based on the focus error signal and the track error signal.

An optical information recording/reproducing device of a present invention, the focus error signal is generated by a differential astigmatism method.

In another aspect of a present invention, an error signal generation method includes: generating, focusing and detecting. In the generating, at least a main beam, a first sub beam and a second sub beam are generated from an output light outputted by a light source. In the focusing, the main beam, the first sub beam and the second sub beam are focused on an optical recording medium which is disc type and has a groove which forms a plurality of tracks by an objective lens. In the detecting, a reflection light of the main beam, a reflection light of the first sub beam and a reflection light of the second sub beam which are reflected by the optical recording medium are received. In the generating, the main beam, the first sub beam and the second sub beam are generated by dividing an incident light into six regions by a tangential direction division line corresponding to a tangential direction of the optical recording medium, a first radial direction division line and a second radial direction division line which correspond to a radial direction of the optical recording medium. A light in the first sub beam passing through an intersection of the first radial direction division line and the tangential direction division line passes through a region near a center of the objective lens. A light in the second sub beam passing through an intersection of the second radial direction division line and the tangential direction division line passes through a region near the center of the objective lens.

Further, in an error signal generation method of a present invention, preferably, a light in the first sub beam passing through an intersection of the second radial direction division line and the tangential direction division line passes through an outside region of an aperture of the objective lens. A light in the second sub beam passing through the first radial direction division line and the tangential direction division line passes through an outside region of the aperture of the objective lens.

In an error signal generation method of a present invention, preferably, in the generating, the main beam, the first sub beam and the second sub beam are generated by a diffraction grating being divided into the six regions which have different characteristic to each other. It is also preferable that the phase of each of the six regions in the diffraction grating is different from the phase of an adjacent region of the six regions by approximately 180°. Further in an error signal generation method of a present invention, the focus error signal is generated by a differential astigmatism method.

According to a present invention, it is possible to provide an optical head device, an optical information recording/reproducing device and an error signal generation method which enable to obtain a favorable focus error signal in which the groove cross noise is sufficiently suppressed. Also, according to a present invention, it is possible to provide an optical head device, an optical information recording/reproducing device and an error signal generation method which enable to obtain a favorable focus error signal for a plural types of optical recording media whose respective groove pitches are different from each other.

### BRIEF DESCRIPTION OF DRAWINGS

FIG. 1 is a plan view of a diffractive optical element used in a conventional optical head device;

FIG. 2 is a plan view of another diffractive optical element used in a conventional optical head device;

FIGS. 3A to 3C are the showing calculation examples of focus error signals;

FIGS. 4A to 4C are views showing positional relations of the section of an incident light to an objective lens and the objective lens in a conventional optical head device;

FIG. 5 is a block diagram showing a configuration of an optical information recording/reproducing device according to an exemplary embodiment of the present invention;

FIG. 6 is a block diagram showing a configuration of an optical head device according to an exemplary embodiment of the present invention;

FIG. 7 shows a plan view of a diffractive optical element included in an optical head device according to an exemplary embodiment of the present invention;

FIG. 8 is a view showing optical paths of a main beam and sub beams from a diffractive optical element to an objective lens;

FIGS. 9A to 9C are views showing positional relations of the section of an incident light to an objective lens in an optical head device and the objective lens according to an exemplary embodiment of the present invention;

FIG. 10 is a view showing an arrangement of the light focus spot on a disc according to an exemplary embodiment of the present invention;

FIG. 11 is a view showing an arrangement of a pattern of a light receiver in an optical detector and an optical spot on an optical detector according to an exemplary embodiment of a present invention; and

FIGS. 12A to 12C are views showing calculation examples of a focus error signal according to an exemplary embodiment of the present invention.

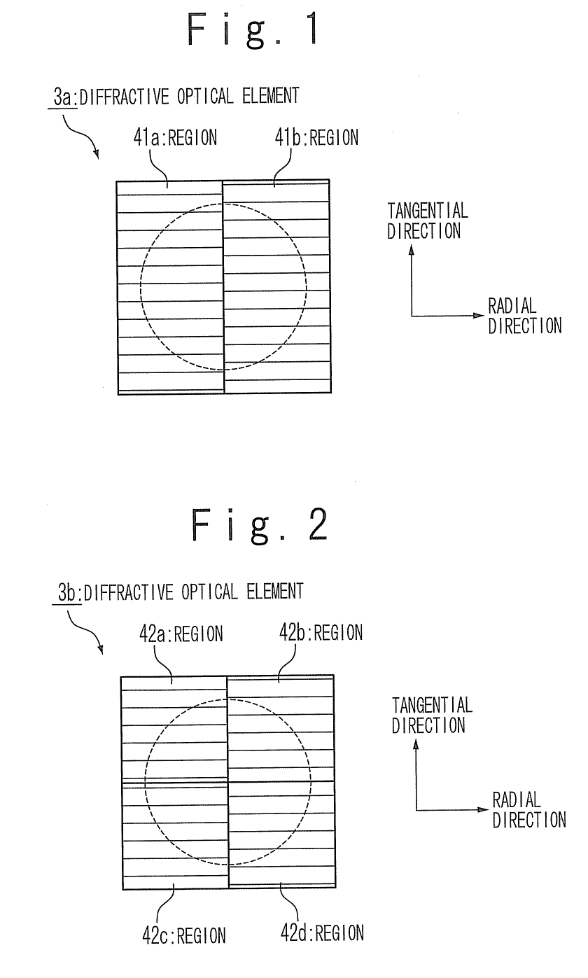

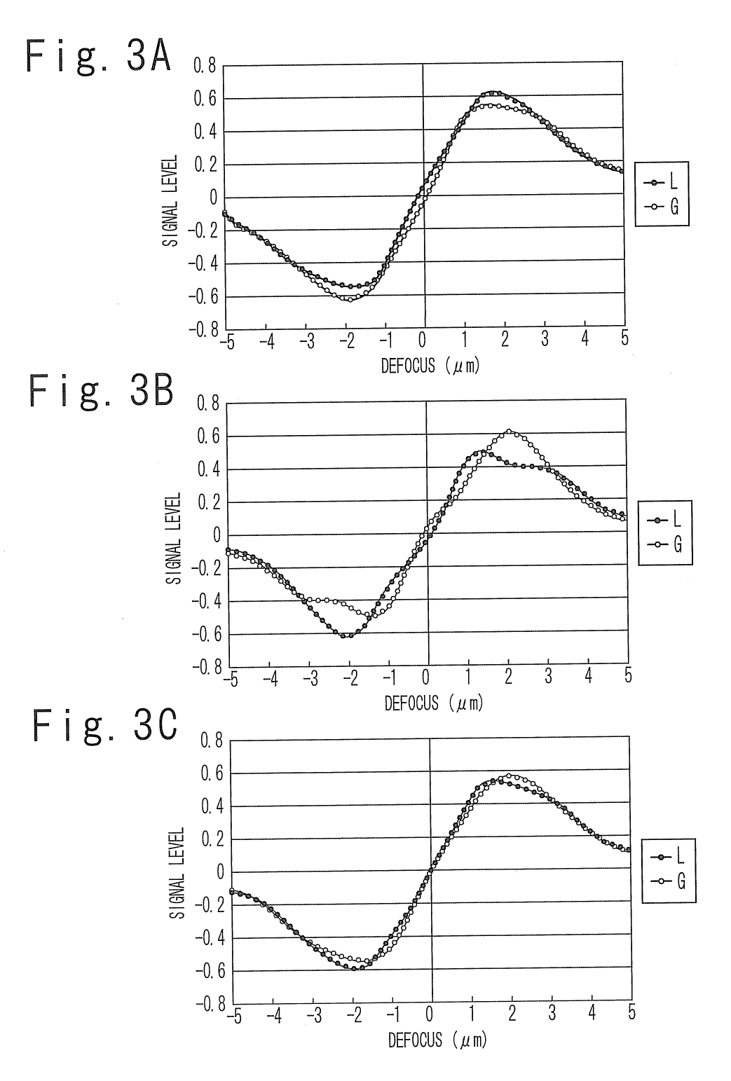

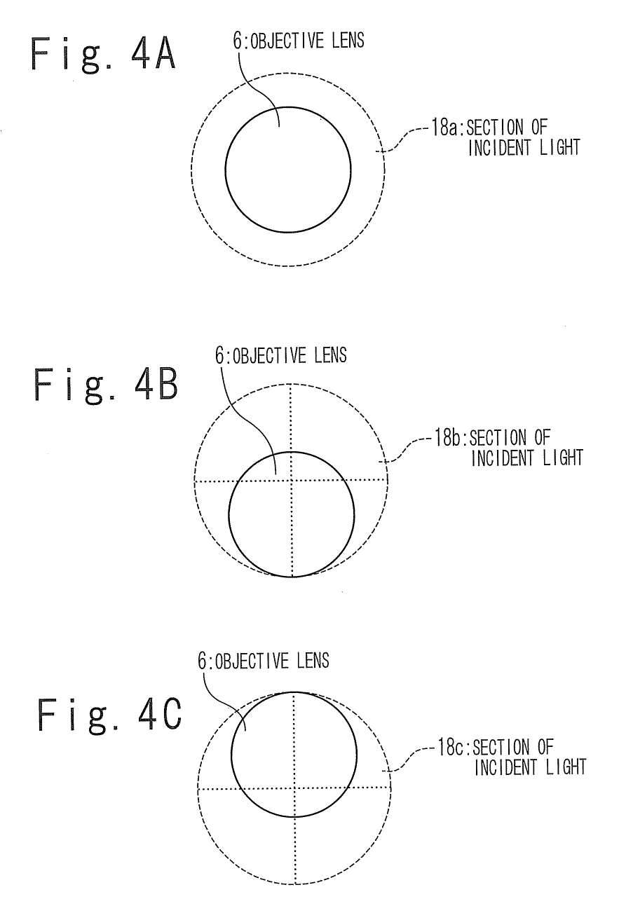

### BEST MODE FOR CARRYING OUT THE INVENTION

Exemplary embodiments of a present invention will be described below in detail with reference to the drawings.

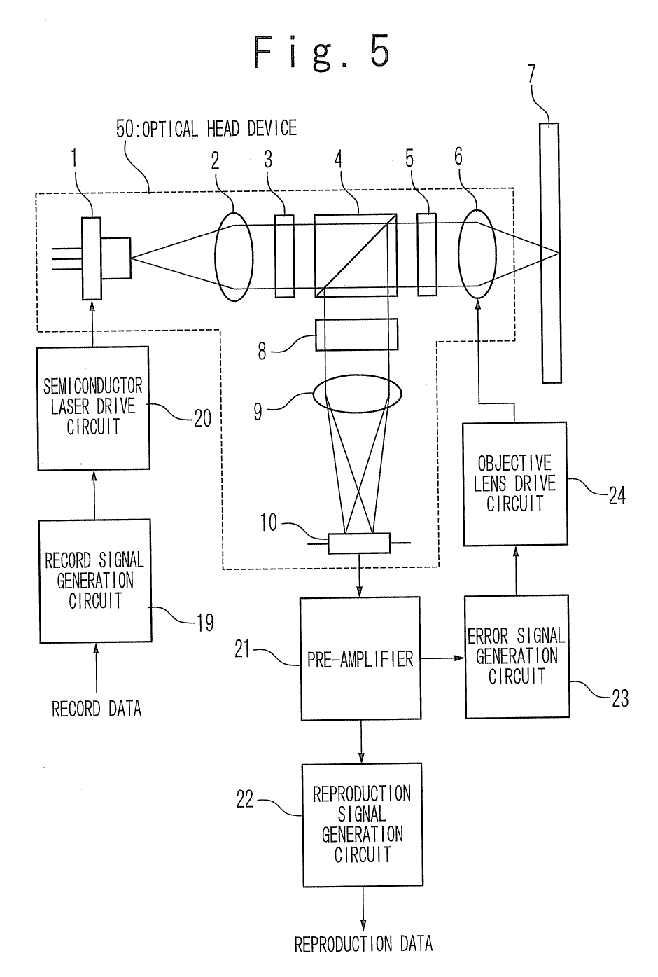

FIG. 5 shows a block diagram showing a configuration of an optical information recording/reproducing device according to an exemplary embodiment of a present invention. The optical information recording/reproducing device includes an optical head device 50, a record signal generation circuit 19, a semiconductor laser drive circuit 20, a pre-amplifier 21, a reproduction signal generation circuit 22, an error signal generation circuit 23 and an objective lens drive circuit 24. The optical head device 50 whose detail is described later includes a semiconductor laser 1, a collimator lens 2, a diffractive optical element 3, a polarization beam splitter 4, a ¼ wavelength plate 5, an objective lens 6, a cylindrical lens 8, a convex lens 9 and an optical detector 10.

The record signal generation circuit 19 generates a record signal for driving the semiconductor laser 1 in accordance with an input record data. The semiconductor laser drive circuit 20 drives the semiconductor laser 1 in accordance with the record signal outputted by the record signal generation circuit 19. According to this process, the signal is recorded onto a disc 7. The semiconductor laser drive circuit 20 corresponds to a first circuit system for driving the light source.

The pre-amplifier 21 converts a current signal outputted by the optical detector 10 into a voltage signal. The reproduction signal generation circuit 22 generates a reproduction signal based on the voltage signal outputted by the pre-amplifier 21 and outputs the reproduction signal to the outside. Thus, the signal from the disc 7 is reproduced.

The error signal generation circuit 23 generates the focus error signal by the differential astigmatism method and the track error signal by the differential push-pull method in order to drive the objective lens 6 based on the voltage signal outputted by the pre-amplifier 21. The objective lens drive circuit 24 drives the objective lens 6 through an actuator (not shown), based on the focus error signal and the track error signal which are outputted by the error signal generation circuit 23. A focus servo and a track servo are operated by this process.

The pre-amplifier 21, the reproduction signal generation circuit 22 and the error signal generation circuit 23 correspond to the second circuit system for detecting the focus error signal, the track error signal, and the RF signal recorded on the optical recording medium based on the output from the optical detector 10. The objective lens drive circuit 24 corresponds to the third circuit system for driving the objective lens 6 based on the focus error signal and the track error signal. Other than them, the optical information recording/reproducing device includes a spindle control circuit for rotating a disc 7, a positioner control circuit for moving the whole optical head device 50 to the disc 7 and the like.

In this exemplary embodiment, a recording/reproducing apparatus for carrying out recording to and reproducing from the disc 7 is exemplified. However, an exclusive reproducing apparatus for carrying out only the reproducing from the disc 7 can be adopted. In such a case, the semiconductor laser 1 is not driven by the semiconductor laser drive circuit 20 based on a record signal, but is always driven to be a constant output.

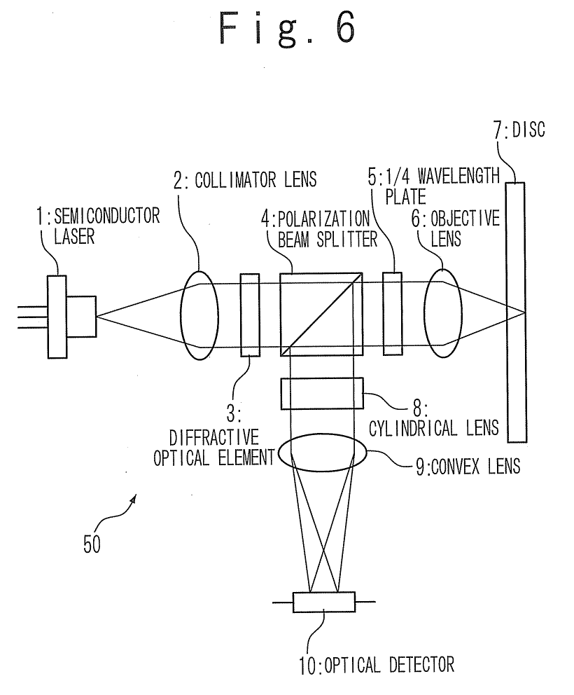

FIG. 6 shows a block diagram showing a configuration of the optical head device 50 in a present invention. The output light from the semiconductor laser 1 serving as a light source is parallelized by the collimator lens 2 and decomposed into three lights of the 0th order light serving as a main beam, a +1st diffracted light serving as a first sub beam and a −1st diffracted light serving as a second sub beam by using the diffractive optical element 3. These lights are inputted to the polarization beam splitter 4 as a P-polarized light and almost all of it is transmitted through it, and transmitted through the ¼ wavelength plate 5 and converted from the linear polarization into the circular polarization and then focused on a same track of the disc 7 serving as an optical recording medium through the objective lens 6.

The reflection light of the main beam, the reflection light of the first sub beam and the reflection light of the second sub beam, which are reflected by the disc 7, pass through the objective lens 6 in the reverse direction, transmitted through the ¼ wavelength plate 5 and then converted from the circular polarization to the linear polarization whose polarization direction is orthogonal to that of the outward path. These lights converted into the linear polarization are inputted to the polarization beam splitter 4 as an S-polarization. Then, almost all of them are reflected and transmitted through the cylindrical lens 8 and the convex lens 9 and received by the optical detector 10.

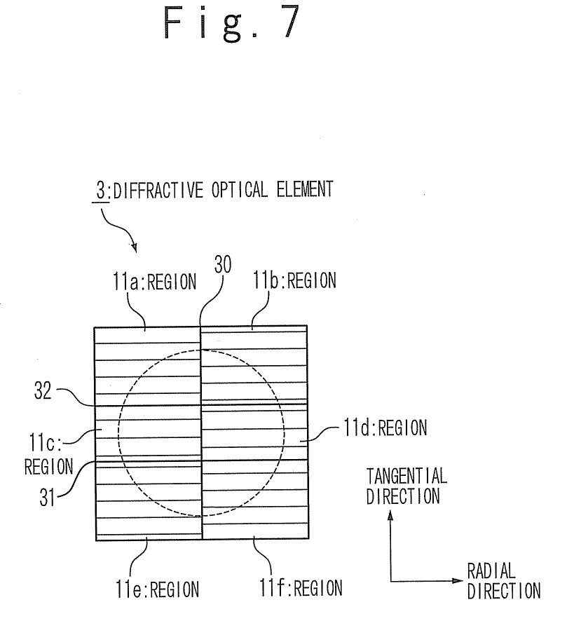

FIG. 7 is a plan view of the diffractive optical element 3. The diffractive optical element 3 is divided into six regions of regions 11a to 11f by: a division line 30 that passes the optical axis of the incident light and corresponds to the tangential direction of the disc 7; and two division lines 31, 32 that are symmetrical with respect to the optical axis of the incident light and correspond to the radius direction of the disc 7. The diffraction gratings are formed in the respective regions. The direction of the diffraction grating is the direction corresponding to the radius direction of the disc, and the patterns of the diffraction gratings have the shapes of the straight lines arranged at a same pitch. The phases of the diffraction gratings in the regions 11a, 11d and 11e and the phases of the diffraction gratings in the regions 11b, 11c and 11f are different from each other by about 180°. Thus, the phases of the +1st diffracted lights from the regions 11a, 11d and 11e and the phases of the +1 st diffracted lights from the regions 11b, 11c and 11f are different from each other by about 180°. Also, the phases of the −1st diffracted lights from the regions 11a, 11d and 11e and the phases of the −1st diffracted lights from the regions 11b, 11c and 11f are different from each other by about 180°. The circle shown by the dotted line on the drawing corresponds to the section of the incident light.

The tangential direction division line 30 on the diffractive optical element 3 is a division line sectioning the regions 11a, 11c and 11e and the regions 11b, 11d and 11f. The first radius direction division line 31 is a division line sectioning the regions 11c, 11d and the regions 11e, 11f. The second radius direction division line 32 is a division line sectioning the regions 11a, 11b and the regions 11c, 11d.

Here, the wavelength of the semiconductor laser 1 is represented by λ, the refractive index of the diffraction grating 3 is represented by n, the height of the diffraction grating 3 is represented by h, and h=0.115 λ/(n−1). Upon this, the transmission factor of the diffraction grating 3 becomes about 87.5%, and ±1st diffraction efficiencies become about 5.1%, respectively. That is, about 87.5% of the light inputted to the diffraction grating 3 is transmitted as the 0th order light, and about 5.1% thereof is diffracted as the ±1st diffracted lights.

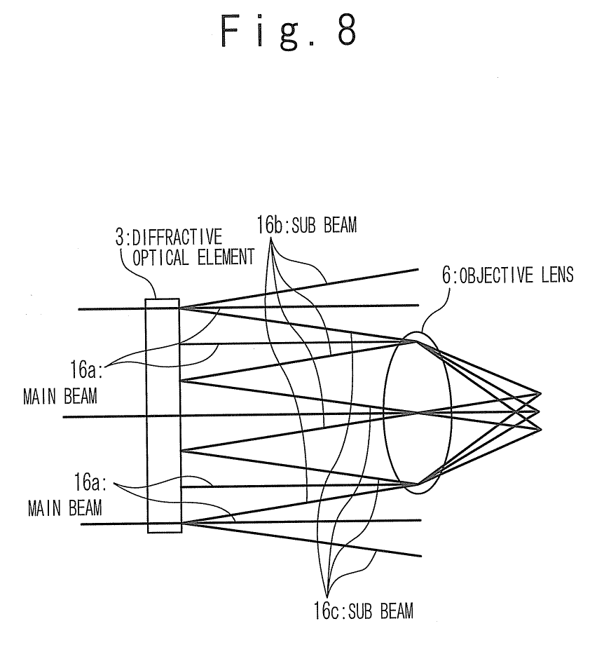

FIG. 8 shows the optical paths of the main beam and the sub beam from the diffractive optical element 3 to the objective lens 6. The main beam 16a transmitted through the diffractive optical element 3 as the 0th order light is sent to the objective lens 6 without being deflected by the diffractive optical element 3. Thus, the optical axis of the main beam 16a inputted to the objective lens 6 passes through the center of the objective lens 6. On the contrary, the sub beam 16b serving as the first sub beam that is diffracted at the diffractive optical element 3 as the +1st diffracted light is deflected to the upper side on the drawing by the diffractive optical element 3 and sent to the objective lens 6. As a result, the optical axis of the sub beam 16b inputted to the objective lens does not pass through the center of the objective lens 6, and is dislocated to the upper side on the drawing with respect to the center of the objective lens 6. The sub beam 16c serving as the second sub beam that is diffracted at the diffractive optical element 3 as the −1st diffracted light is deflected to the lower side on the drawing by the diffractive optical element 3 and sent to the objective lens 6. As a result, the optical axis of the sub beam 16c inputted to the objective lens 6 does not pass through the center of the objective lens 6, and is dislocated to the lower side on the drawing with respect to the center of the objective lens 6.

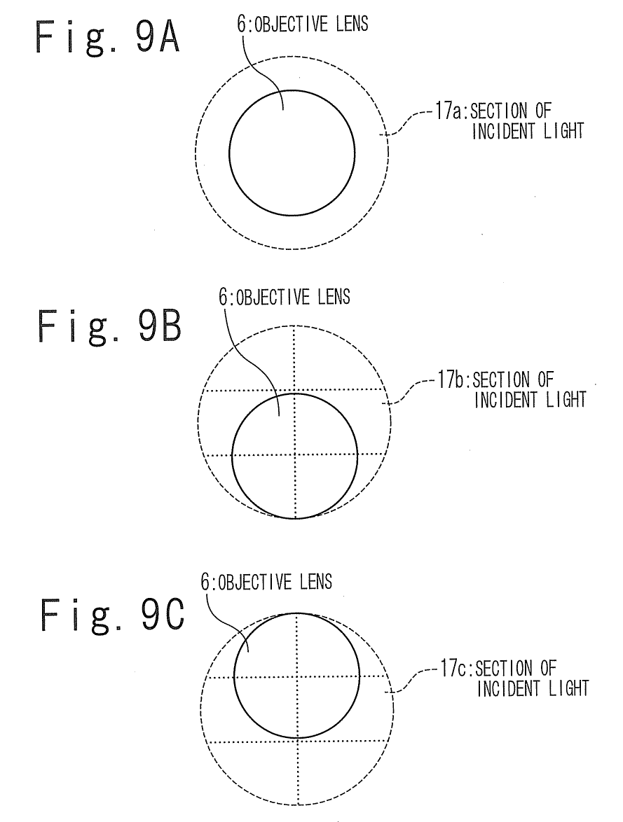

The positional relation of the section of the incident light to the objective lens 6 and the objective lens 6 in this case is shown in FIGS. 9A to C. FIG. 9A shows the positional relation of the section of the main beam 16a and the objective lens 6. The center of the section 17a of the incident light indicated by the dashed line on the drawing and the center of the objective lens 6 are coincident with each other.

FIG. 9B shows the positional relation of the sub beam 16b that is the first sub beam and the objective lens 6. The center of the section 17b of the incident light indicated by the dashed line on the drawing is dislocated to the upper side on the drawing with respect to the center of the objective lens 6. The three straight lines indicated by the dotted lines on the drawing correspond to the three division lines of the diffractive optical element 3, namely, the tangential direction division line 30, the first radius direction division line 31 and the second radius direction division line 32, respectively. The intersection of the two straight lines, which correspond to the tangential direction division line 30 and the first radius direction division line 31 of the diffractive optical element 3, coincides with the center of the objective lens 6. The intersection of the two straight lines, which correspond to the tangential direction division line 30 and the second radius direction division line 32 of the diffractive optical element 3, is not located inside the objective lens 6. Thus, as for the sub beam 16b, the rates of the lights respectively diffracted in the regions 11c, 11d, 11e and 11f of the diffractive optical element 3 and inputted to the objective lens 6 become equal to each other.

FIG. 9C shows the positional relation of the sub beam 16c that is the second sub beam and the objective lens 6. The center of the section 17c of the incident light indicated by the dashed line on the drawing is dislocated to the lower side on the drawing with respect to the center of the objective lens 6. The three straight lines indicated by the dotted lines on the drawing correspond to the three division lines of the diffractive optical element 3, namely, the tangential direction division line 30, the first radius direction division line 31 and the second radius direction division line 32, respectively. The intersection of the two straight lines, which correspond to the tangential direction division line 30 and the second radius direction division line 32 of the diffractive optical element 3, coincides with the center of the objective lens 6. The intersection of the two straight lines, which correspond to the tangential direction division line 30 and the first radius direction division line 31 of the diffractive optical element 3, is not located inside the objective lens 6. Thus, as for the sub beam 16c, the rates of the lights respectively diffracted in the regions 11a, 11b, 11c and 11d of the diffractive optical element 3 are inputted to the objective lens 6 become equal to each other.

The interval between the first radius direction division line 31 and the second radius direction division line 32 of the diffractive optical element 3 can be determined in accordance with the optical path between the diffractive optical element 3 and the objective lens 6 and the diffraction angles of the ±1st diffracted lights in the diffractive optical element 3.

The input region of the objective lens 6 is divided into four regions by a straight line which passes through the center of the objective lens 6 and is parallel to the tangential direction of the disc 7, and a straight line which passes the center of the objective lens 6 and is parallel to the radius direction of the disc 7. Then, the phases of the lights inputted to the respective regions are compared to each other. In the case of the first sub beam 16b, as shown in FIG. 9B, the division line of the input region of the objective lens 6 and the straight line corresponding to the division line of the diffractive optical element 3 are coincident with each other. Then, the phases of the lights inputted to the two regions located at one corner and the phases of the lights inputted to the two regions located at the opposing corner are different from each other by about 180°. Also in the case of the second sub beam 16c, as shown in FIG. 9C, the division line of the input region of the objective lens 6 and the straight line corresponding to the division line of the diffractive optical element 3 are coincident with each other. Then, the phases of the lights inputted to the two regions located at one corner and the phases of the lights inputted to the two regions located at the opposing corner are different from each other by about 180°.

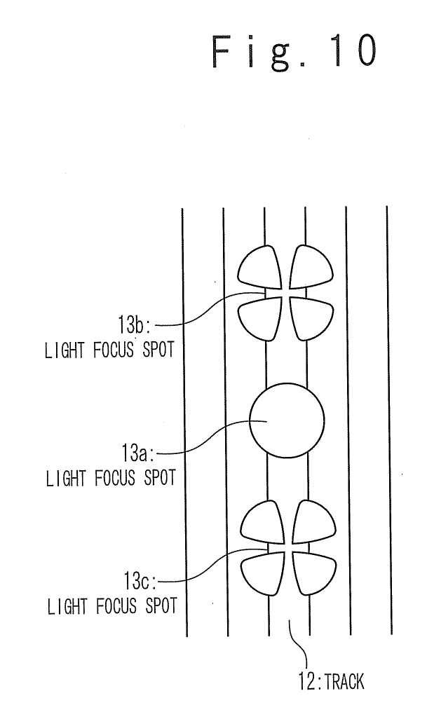

FIG. 10 shows an arrangement of the light focus spots on the disc 7. Light focus spots 13a, 13b and 13c correspond to the 0th order light, the +1st diffracted light and the −1st diffracted light from the diffractive optical element 3, respectively. The three light focus spots are arranged on a same track 12.

Each of the light focus spot 13b serving as the first sub beam and the light focus spot 13c serving as the second sub beam has four peaks whose magnitudes are equal to each other on an upper left side, an upper right side, a lower left side and a lower right side, which are separated by a straight line parallel to the tangential direction of the disc 7 and a straight line parallel to the radius direction. In this exemplary embodiment, three light focus spots are arranged on a same track and the influence of the pitch of the groove is removed. Thus, it is possible to carry out recording to/reproducing from plural types of the optical recording media whose groove pitches are different from each other.

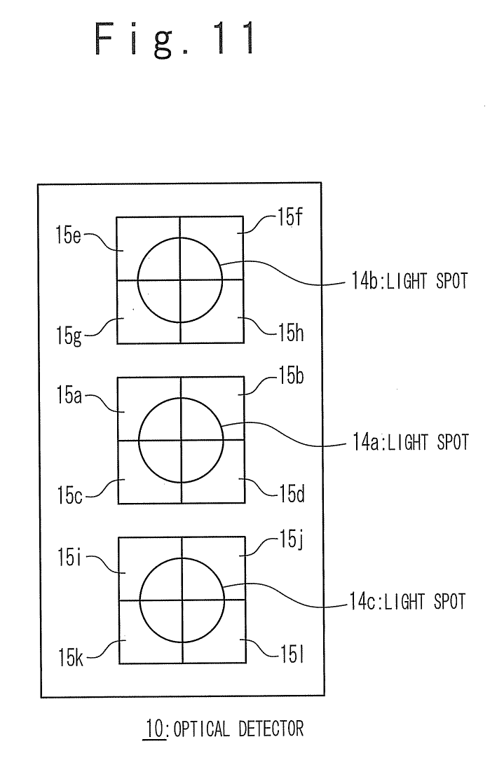

FIG. 11 shows the positional relation of the light receiver of the optical detector 10 and the optical spots formed on the optical detector 10. The optical spot 14a corresponds to the 0th order light from the diffractive optical element 3 which is the main beam and is received by light receivers 15a to 15d which are quartered by the division line corresponding to the tangential direction of the disc 7 and the division line corresponding to the radius direction. The optical spot 14b corresponds to the +1st diffracted light from the diffractive optical element 3 which is the first sub beam and is received by light receivers 15e to 15h which are quartered by the division line corresponding to the tangential direction of the disc 7 and the division line corresponding to the radius direction. The optical spot 14c corresponds to the −1st diffracted light from the diffractive optical element 3 which is the second sub beam and is received by light receivers 15i to 15l which are quartered by the division line corresponding to the tangential direction of the disc 7 and the division line corresponding to the radius direction. Here, the direction corresponding to the tangential direction of the disc 7 is exchanged for the direction corresponding to the radius direction thereof by the function of the cylindrical lens 8.

By representing the outputs from the light receivers 15a to 15l by V15a to V15l, respectively, the push-pull signal MPP corresponding to the main beam, the focus error signal MFE corresponding to the main beam, the push-pull signal SPP corresponding to the sub beam and the focus error signal SFE corresponding to the sub beam are given by the following equations, respectively.

MPP=(V15a+V15b)−(V15c+V15d)

SPP=(V15e+V15f+V15i+V15j)−(V15g+V15h+V15k+V15l)

MFE=(V15a+V15d)−(V15b+V15c)

SFE=(V15e+V15h+V15i+V15l)−(V15f+V15g+V15j+V15k)

The track error signal DPP of the differential push-pull method and the focus error signal DFE of the differential astigmatism method are given by the following equations, respectively.

DPP=MPP−K1×SPP (K1 is a constant)

DFE=MFE+K2×SFE (K2 is a constant)

Moreover, the RF signal recorded on the disc 7 is obtained from high frequency components of (V15a+V15b+V15c+V15d).

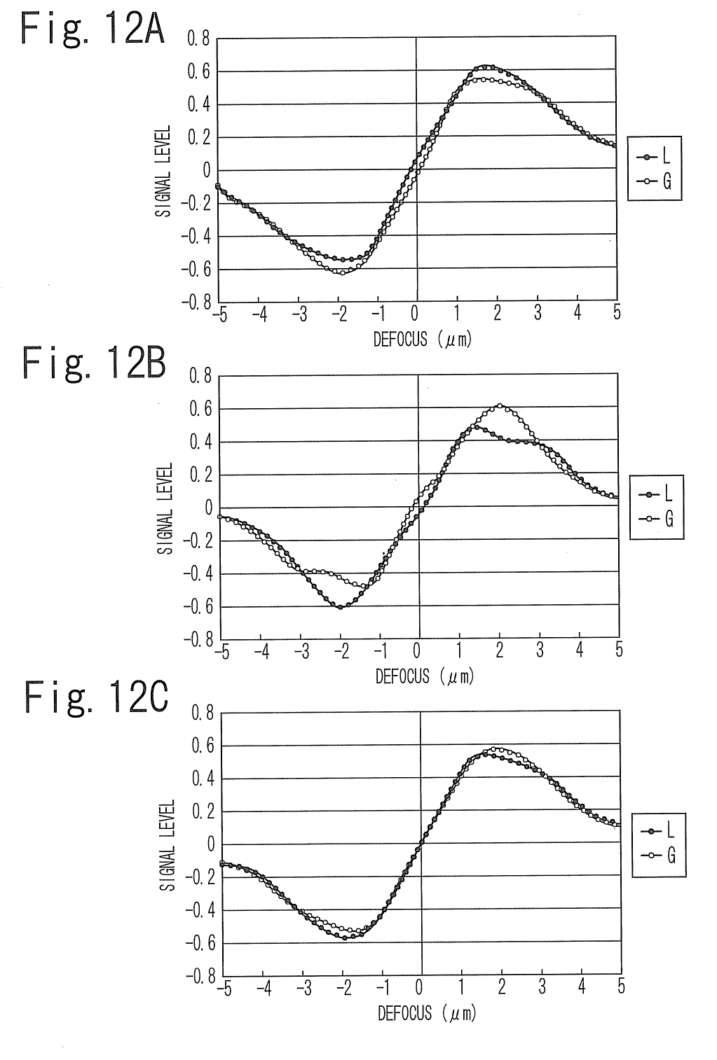

FIGS. 12A to C show calculation examples of the focus error signal. FIGS. 12A to C show the calculation examples in which in the four regions divided by: the straight line that passes through the center of the objective lens and is parallel to the tangential direction of the disc; and the straight line that passes through the center of the object lens and is parallel to the radius direction of the disc, the phases of the sub beams in the two regions located at one corner and the phases of the sub beams in the two regions located at the opposing corner are different from each other by about 180°.

FIG. 12A shows a calculation example of the focus error signal MFE of the main beam which is normalized by a sum signal MSUM corresponding to the main beam. FIG. 12B shows a calculation example of the focus error signal SFE of the sub beam which is normalized by a sum signal SSUM corresponding to the sub beam. FIG. 12C shows a calculation example of the focus error signal DFE of the astigmatism method which is normalized by 2×MSUM, wherein K2=MSUM/SSUM. The horizontal axis of the graph indicates the defocus amount of the disc, and the vertical axis indicates the signal level of the focus error signal. The black dots in the graph represent the focus error signal when the light focus spot is located on the land, and the white dots represent the focus error signal when the light focus spot is located on the groove. The calculation condition is that: the wavelength of the light source is 405 nm, the numeric aperture of the objective lens is 0.65, the pitch of the groove is 0.68 μm, and the depth of the groove is 45 nm.

In the calculation examples shown in FIGS. 12A to C, when only the main beam is used to detect the focus error signal based on a simple astigmatism method, as shown in FIG. 12A, the waveform of the focus error signal on the land and the waveform of the focus error signal on the groove are different from each other, thereby the groove cross noise is generated. On the contrary, when the main beam and the sub beam are used to detect the focus error signal based on the differential astigmatism method, as shown in FIG. 12C, the waveform of the focus error signal on the land and the waveform of the focus error signal on the groove are approximately coincident with each other in the range in which the defocus amount is below ±1.5 μm so that the groove cross noise can be sufficiently suppressed. This is because the waveform of the focus error signal corresponding to the main beam shown in FIG. 12A and the waveform of the focus error signal corresponding to the sub beam shown in FIG. 12B are opposite to each other on the land and on the groove, in the range in which the defocus amount is below ±1.5 μm, and by added them, the difference of the waveforms on the land and on the groove is sufficiently canceled.

The focus error signal in this exemplary embodiment becomes the signals shown in FIGS. 12A to C. That is, in this exemplary embodiment, the waveform of the focus error signal on the land and the waveform of the focus error signal on the groove are approximately coincident with each other. Thus, the range of the defocus amount in which the groove cross noise can be suppressed by using the differential astigmatism method is wide, and a favorable focus error signal whose groove cross noise is sufficiently suppressed can be obtained.

As mentioned above, in an optical head device and an optical information recording/reproducing device of a present invention, the intersection of the two straight lines that correspond to the tangential direction division line and the first radius direction division line of the diffractive optical element in the section of the first sub beam inputted to the objective lens can be made approximately coincident with the center of the objective lens. Thus, as for the first sub beam, the rates of the lights respectively diffracted in the four regions of the diffractive optical element which are divided by the tangential direction division line and the first radius direction division line and inputted to the objective lens become nearly equal to each other.

Further, the intersection of the two straight lines that correspond to the tangential direction division line and the second radius direction division line of the diffractive optical element in the section of the second sub beam inputted to the objective lens can be made approximately coincident with the center of the objective lens. Thus, as for the second sub beam, the rates of the lights respectively diffracted in the four regions of the diffractive optical element which are divided by the tangential direction division line and the second radius direction division line and inputted to the objective lens 6 become nearly equal to each other.

The focus error signal in this case becomes the signals shown in FIGS. 12A to C. That is, in an optical head device and an optical information recording/reproducing device of a present invention, the waveforms of the respective focus error signals on the land and on the groove are approximately coincident with each other, and the range of the defocus amount in which the groove cross noise can be suppressed by using the differential astigmatism method is wide, so that the groove cross noise can be sufficiently suppressed.

As mentioned above, in the section of the first sub beam inputted to the objective lens, the intersection of the two straight lines, which correspond to the tangential direction division line and the first radius direction division line of the diffractive optical element, approximately coincides with the center of the objective lens. In the section of the second sub beam inputted to the objective lens, the intersection of the two straight lines, which correspond to the tangential direction division line and the second radius direction division line of the diffractive optical element, approximately coincides with the center of the objective lens. Thus, it is possible to provide an optical head device, an optical information recording/reproducing device and an error signal generation method which enable to obtain a favorable focus error signal whose groove cross noise is sufficiently suppressed. Also, it is possible to provide an optical head device, an optical information recording/reproducing device and an error signal generation method which enable to obtain a favorable focus error signal for plural types of optical recording media whose groove pitches are different from each other.

What is claimed:

1. An optical head device comprising:
a light source;
a diffractive optical element configured to generate at least a main beam, a first sub beam and a second sub beam from an output light outputted by the light source;
an objective lens configured to focus the main beam, the first sub beam and the second sub beam generated by the diffractive optical element on an optical recording medium which is disc type and has a groove which forms a plurality of tracks; and
an optical detector configured to receive a reflection light of the main beam, a reflection light of the first sub beam and a reflection light of the second sub beam which are reflected by the optical recording medium,
wherein the diffractive optical element is divided into six regions having different optical characteristics to each other by a tangential direction division line corresponding to a tangential direction of the optical recording medium, a first radial direction division line and a second radial direction division line which correspond to a radial direction of the optical recording medium,
a light in the first sub beam passing through an intersection of the first radial direction division line and the tangential direction division line passes through a region near a center of the objective lens, and
a light in the second sub beam passing through an intersection of the second radial direction division line and the tangential direction division line passes through a region near the center of the objective lens.

2. The optical head device according to claim 1, wherein a light in the first sub beam passing through an intersection of the second radial direction division line and the tangential direction division line passes through an outside region of an aperture of the objective lens, and
a light in the second sub beam passing through the first radial direction division line and the tangential direction division line passes through an outside region of the aperture of the objective lens.

3. The optical head device according to claim 1, wherein the diffractive optical element has a diffraction grating, and
a phase of the diffraction grating in each of the regions is different from a phase of the diffraction grating in an adjacent region of the regions by approximately 180°.

4. The optical head device according to claim 3, wherein the regions includes a first region group and a second region group, wherein the first region group includes:
an upper left region in a left side of the tangential direction division line and an upper side of the first radial direction division line and the second radial direction division line;
a center right region in a right side of the tangential direction division line and pinched between the first radial direction division line and the second radial direction division line; and
a lower left region in a left side of the tangential direction division line and a lower side of the first radial direction division line and the second radial direction division line, and
the second region group includes:
an upper right region in a right side of the tangential direction division line and an upper side of the first radial direction division line and the second radial direction division line;
a center left region in a left side of the tangential direction division line and pinched between the first radial direction division line and the second radial direction division line; and
a lower right region in a right side of the tangential direction division line and a lower side of the first radial direction division line and the second radial direction division line, and
a phase of the diffraction grating in the first region group and a phase of the diffraction grating in the second region group are different from each other by approximately 180°.

5. The optical head device according to claim 1, wherein the main beam, the first sub beam and the second sub beam are a 0th order light, a +1st order diffracted light and a −1st order diffracted light generated by decomposing the output light outputted by the light source, respectively.

6. The optical head device according to claim 1, wherein the objective lens is configured to focus the main beam, the first sub beam and the second sub beam on a same track of the plurality of tracks.

7. An optical information recording/reproducing device comprising:
an optical head device according to any of claim 1;
a first circuit configured to drive the light source;
a second circuit configured to detect an RF signal recorded on the optical recording medium, a focus error signal and a track error signal based on a signal outputted by the optical detector; and
a third circuit configured to drive the objective lens based on the focus error signal and the track error signal.

8. The optical information recording/reproducing device according to claim 7, wherein the focus error signal is generated by a differential astigmatism method.

9. An error signal generation method comprising:
generating at least a main beam, a first sub beam and a second sub beam from an output light outputted by a light source;
focusing the main beam, the first sub beam and the second sub beam on an optical recording medium which is disc type and has a groove which forms a plurality of tracks by an objective lens; and
receiving a reflection light of the main beam, a reflection light of the first sub beam and a reflection light of the second sub beam which are reflected by the optical recording medium,
wherein the generating includes:
generating the main beam, the first sub beam and the second sub beam by dividing an incident light into six regions by a tangential direction division line corresponding to a tangential direction of the optical recording medium, a first radial direction division line and a second radial direction division line which correspond to a radial direction of the optical recording medium,
a light in the first sub beam passing through an intersection of the first radial direction division line and the tangential direction division line passes through a region near a center of the objective lens, and
a light in the second sub beam passing through an intersection of the second radial direction division line and the tangential direction division line passes through a region near the center of the objective lens.

10. The error signal generation method according to claim 9, wherein a light in the first sub beam passing through an intersection of the second radial direction division line and the tangential direction division line passes through an outside region of an aperture of the objective lens, and
a light in the second sub beam passing through the first radial direction division line and the tangential direction division line passes through an outside region of the aperture of the objective lens.

11. The error signal generation method according to claim 9, wherein the generating at least a main beam, a first sub beam and a second sub beam includes:
generating the main beam, the first sub beam and the second sub beam by a diffraction grating being divided into the six regions which have different characteristic to each other, and
a phase of each of the six regions in the diffraction grating is different from a phase of an adjacent region of the six regions by approximately 180°.

12. The error signal generation method according to claim 9, wherein the focus error signal is generated by a differential astigmatism method.
